(19) United States
(12) Patent Application Publication
(10) Pub. No.: US 2009/0094908 A1
(43) Pub. Date: Apr. 16, 2009

(54) Flexible Fire-Resistant Thermally Insulated Composite Structures

(76) Inventors: Jill A. Krueger, Westerville, OH (US); Anthony L. Rockwell, Pickerington, OH (US); John K. Hodges, Powell, TN (US)

Correspondence Address: OWENS CORNING, 2790 COLUMBUS ROAD, GRANVILLE, OH, 43023, US

(21) Appl. No.: 12/249,542

(22) Filed: Oct. 10, 2008

Related U.S. Application Data
(60) Provisional application No. 60/998,958, filed on Oct. 15, 2007.

(51) Int. Cl. E06B 3/263; E04B 1/78

(52) U.S. Cl. 52/202; 52/404.4; 52/656.3

(57) ABSTRACT

The instant invention includes a flexible fire-resistant thermally insulated composite structure designed in some embodiments to pass through an opening. The structure may be self-supporting due to the stiffness of various layers, and battens may contribute to the self-supporting capacity of the structure.

The flexible composite structure may have a collapsed transit configuration, allowing the structure to be compressed to more easily pass it through an opening, a rotable attachment to allow the structure to rotate away from the opening, and a releasable attachment for attaching the structure around an opening periphery. In another embodiment, the structure may also include a bottom and such a structure could provide shelter in conditions ranging from ambient environmental conditions to the extreme heat of certain fires.

The insulative structures of the instant invention are not limited to embodiments designed to rest on generally horizontal surfaces. For example, it may be desirable to utilize such a structure to block an attic fan, or other roof penetration, during certain seasons of the year. Such an embodiment may also include a releasable attachment configured for releasably attaching the installation periphery to a surface inclined from the horizontal.

This application claims priority to U.S. provisional patent application Ser. No. 60/998,958, filed Oct. 15, 2007, which is hereby incorporated by reference in its entirety.

### TECHNICAL FIELD AND INDUSTRIAL APPLICABILITY OF THE INVENTION

The invention relates to the field of self-supporting insulative structures, particularly to flexible fire-resistant thermally insulated composite structures.

### BACKGROUND OF THE INVENTION

Control of energy use and expenses have made the control of heat transfer within residential and commercial structures a high priority for both new construction and building retrofits. A common source of surprisingly high heat losses is from heated or cooled areas, such as living areas, into relatively uncontrolled areas, such as attics or crawlspaces. Additionally, unwanted heat transfers can take place from various areas directly to the outdoors. A common response has been to increase the amount or thermal insulative ability of insulation placed between such areas.

A constant tension in controlling this type of heat transfer is caused by the need to maintain access into such uncontrolled areas, or into the outdoors. For example, the goal of sealing an attic space is opposed by the need to maintain access, commonly through a trap-door or stairs, into such an attic space. These access demands may be seasonal or year around; for example, an attic fan may need direct access to the outside during the summer to exhaust hot air from an attic, but may be inactive and need no such access during the winter.

In the past, attention has focused in several areas in this regard. Firstly, there have been attempts to make access structures, such as doors, more insulative. A typical example is seen in U.S. Pat. No. 4,299,059 ('059). The '059 patent teaches the interposition of several layers of insulative materials on a ceiling-mounted attic door to improve the thermal insulative capacity of such a door when it is in a normally closed position.

Attention has also been directed towards placing generally rigid insulative structures on one side of a thermal opening, most generally on the thermally less controlled side. A typical example is seen in U.S. Pat. No. 4,658,555 ('555). Such devices are essentially rigid boxes meant to overlay an opening and to both cut air flow and increase the insulative capacity of such an opening.

Openings in surfaces and into spaces are, of course, generally provided so that people and things may pass through such openings. For example, even if access to an attic space is only occasional, any supplemental structure must not unduly burden such access. Rigid boxes provide special challenges; for example, even a small air gap between the box and the perimeter of the opening may greatly affect the heat transfer. Rigid boxes generally require mounting hardware, and sufficient swing space must be allotted to allow most designs to open easily.

Additionally, rigid insulative structures are ill suited to applications to surfaces that are inclined away from the horizontal, such as openings through cathedral ceiling or other angulated surfaces, due to their bulk and weight. The instant invention solves these and many other concerns expressed in the prior art, all in new and novel ways.

### SUMMARY OF THE INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations.

The instant invention includes a flexible fire-resistant thermally insulated composite structure designed in some embodiments to pass through an opening that it is designed to insulate. For the purposes of this specification, “fire resistant” is intended to mean only that the structure is generally designed to resist certain higher heat temperatures for a certain period of time. The flexible composite structure is formed to have a self-supported installation configuration, enabling the flexible composite structure to support the composite structure mass. In some embodiments, the structure is self-supporting due to the stiffness of the insulative layer, the protective layer, or sometimes both. In other embodiments, battens contribute at least in part to the self-supporting capacity of the structure.

The flexible composite structure may have a collapsed transit configuration, allowing the structure to be compressed to more easily pass it through an opening. The structure includes a thermally insulative layer and a protective layer, both of which may be formed from a plurality of materials well known in the art and discussed further below, and any portion of the structure may be treated with a fire retardant.

The protective layer may fully encapsulate the thermally insulative layer or may leave a portion of the insulative layer exposed. The protective layer may include at least one foil, or polyvinylchloride, layer which may be disposed on one or a plurality of surfaces of the structure, and may also comprise polyester and/or polyester blends.

At least a portion of the insulative layer and at least a portion of the protective layer may be bonded together. Such bonding may increase the durability of structure and make manipulation of the structure easier. The flexible fire-resistant thermally insulated composite structure may further include at least one grip enhancing device, which may typically be handles or tabs, to allow the easy manipulation of the structure while minimizing the chances of damage.

The structure may have a rotable attachment to allow the structure to rotate away from the opening for ingress and egress while the structure would tend to remain properly oriented relative to the opening The structure may also have a releasable attachment for releasably attaching the structure around an opening periphery. Such a releasable attachment tends to improve the thermal seal at the region of the junction of the structure and the opening periphery and tends to keep the structure properly aligned with the opening, but, being releasable, also allows for ingress and egress through the opening when needed.

The flexible fire-resistant thermally insulated composite structure may further include a plurality of weight elements. This is particularly valuable when the inherent stiffness of the structure is relatively low, as the weight elements may tend to keep the structure stretched across the opening without an excess sag. Weight elements may also partially compensate for the relatively low weight of some embodiments of the structure, and tend to keep the structure properly aligned with the opening and less susceptible to unintended movement due to accidental contact or jostling.

As described above, in still another embodiment, the flexible fire-resistant thermally insulated composite structure may further include at least one batten. The at least one batten may generally be formed with or attached to any surface or part of the structure, and may, in some embodiments, be attached to one or more of the group of layers consisting of the insulative layer and the protective layer. The provision of battens may have many beneficial effects, such that they may stiffen a structure whose inherent stiffness is inadequate to support the structure without excessive sag. Battens may also help a structure maintain its shape in any dimension. Furthermore, battens may improve the overall durability and handling ease of the structure.

Battens may be formed to create a curl in an otherwise generally flat structure. A mechanism may be provided by which the insulative layer and the protective layer of the structure might be rolled up against the resistance of such battens.

The structure may be formed as a single piece or may further comprise a plurality of sections. Such a sectional construction may, particularly if the structure is large, enable easier installation and removal of the structure or may simplify ingress and egress through an opening. Each of the plurality of sections may be configured to at least partially overlap, or may be attached to one another. Such attachment may help keep the structure together, and may help improve the thermal seal between the sections.

In another embodiment, not necessarily designed to be passed through an opening, the flexible fire-resistant thermally insulated composite structure may also include a bottom. The bottom may be attached circumferentially to the installation periphery to form an interior volume within the structure. Such an insulative structure may have an ingress and egress means, and could be used as a shelter, possibly deployed under emergency conditions. Depending on the fire resistance, discussed above, such a structure could provide shelter in conditions ranging from ambient environmental conditions to the extreme heat of certain fires.

The insulative structures of the instant invention are not limited to embodiments designed to rest on generally horizontal surfaces. For example, it may be desirable to utilize such a structure to seal around an attic fan, or other roof penetration, during certain seasons of the year. Such an embodiment may also include a releasable attachment configured for releasably attaching the installation periphery to a surface inclined from the horizontal. Such an attachment, by way of example only, may be configured as a continuous or partial hook and loop closure section, and could hold the structure in releasable contact when the installation does not rest on a horizontal surface.

The structure may be a component of a system for insulating an opening. Such a system may allow at least in part for the retention of loose insulation or other debris in a typical attic installation, with the provision of a collar and sidewall disposed about and attached to the opening periphery. The collar and associated sidewall will decrease the natural tendency of any loose insulation, or other debris, from falling through the opening into a space below.

### BRIEF DESCRIPTION OF THE DRAWINGS

Without limiting the scope of the present invention as claimed below and referring now to the drawings and figures, all of which are not to scale:

FIG. 1 is a perspective drawing of an embodiment of the instant invention shown in functional relationship to a prior art attic stairway;

FIG. 2 is a perspective drawing of an alternate embodiment of the instant invention shown in functional relationship to a prior art attic stairway;

FIG. 3 is a perspective drawing of an alternate embodiment of the instant invention shown in functional relationship to a prior art attic stairway;

FIG. 4 is an elevated perspective drawing of prior art;

FIG. 5 is an elevated perspective drawing of an embodiment of the instant invention shown in functional relationship to an opening;

FIG. 6 is an elevated perspective drawing of an embodiment of the instant invention shown in functional relationship to an opening;

FIG. 7 is a cross sectional drawing of an embodiment of the instant invention in functional relationship with a prior art attic stairway;

FIG. 8 is a cross sectional drawing of an alternate embodiment of the instant invention in functional relationship with a prior art attic stairway;

FIG. 9 is a cross sectional drawing of an alternate embodiment of the instant invention in functional relationship with a prior art attic stairway;

FIG. 10 is a cross sectional drawing of an alternate embodiment of the instant invention in functional relationship with a prior art attic stairway;

FIG. 11 is a cross sectional drawing of an alternate embodiment of the instant invention in functional relationship with a prior art attic stairway;

FIG. 12 is an elevated perspective drawing of an embodiment of the instant invention;

FIG. 13 is an elevated perspective drawing of an alternate embodiment of the instant invention;

FIG. 14 is an elevated perspective drawing of an alternate embodiment of the instant invention;

FIG. 15 is an elevated perspective drawing of an alternate embodiment of the instant invention;

FIG. 16 is a cross sectional drawing of an alternate embodiment of the instant invention in functional relationship with a prior art attic stairway;

FIG. 17 is a cross sectional drawing of an alternate embodiment of the instant invention in functional relationship with a prior art attic stairway;

FIG. 18 is an elevated perspective drawing of an alternate embodiment of the instant invention;

FIG. 19 is a elevated perspective drawing of an alternate embodiment of the instant invention;

FIG. 20 is a partially exploded perspective drawing of an alternate embodiment of the instant invention; and

FIG. 21 is an elevated perspective drawing of an alternate embodiment of the instant invention.

These drawings are provided to assist in the understanding of the exemplary embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION AND PREFERRED EMBODIMENTS OF THE INVENTION

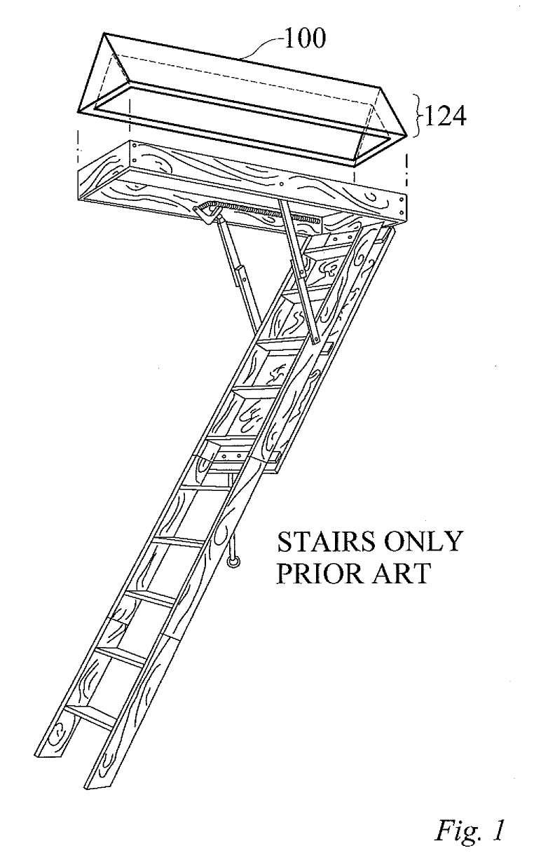

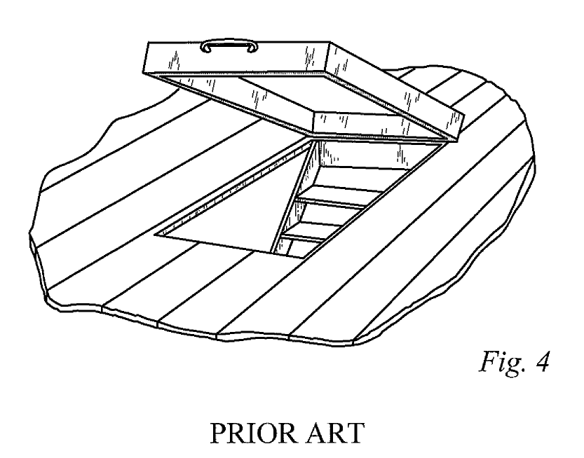

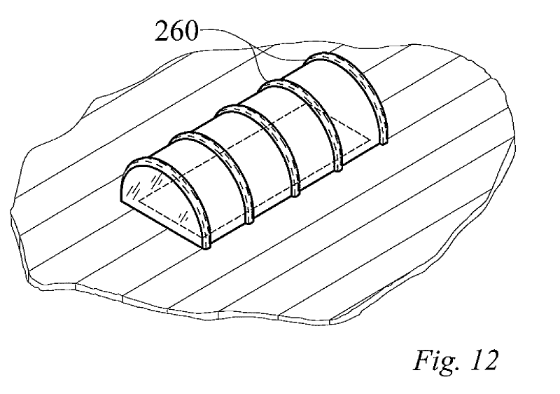

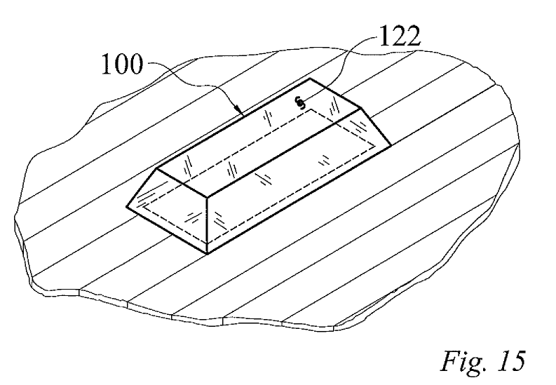

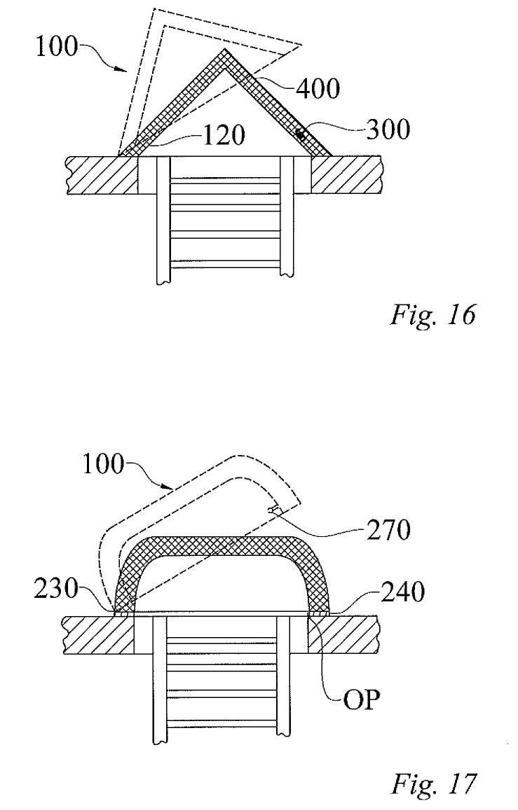

With reference generally now to FIGS. 1 through 21, the flexible fire-resistant thermally insulated composite structure (100) of the instant invention enables a significant advance in the state of the art. The preferred embodiments of the device accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

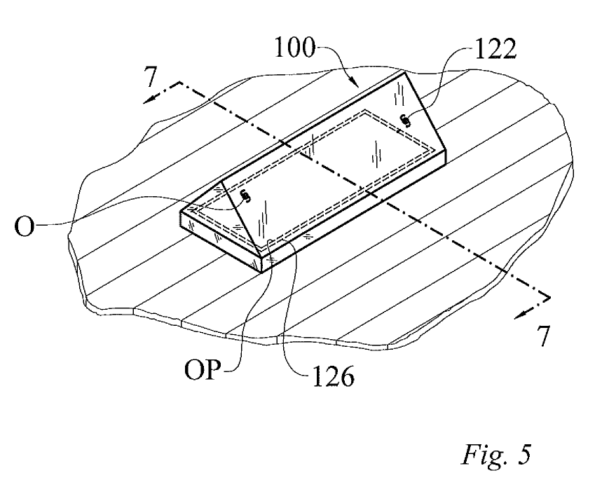

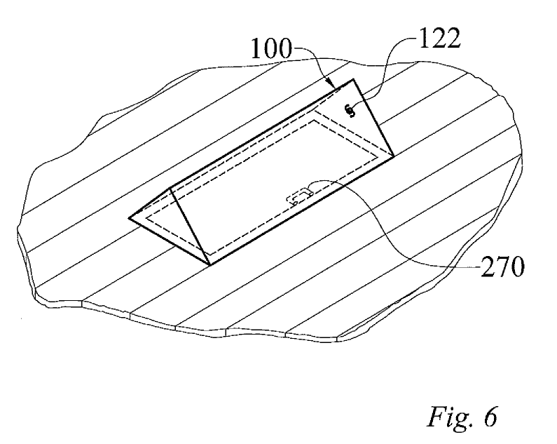

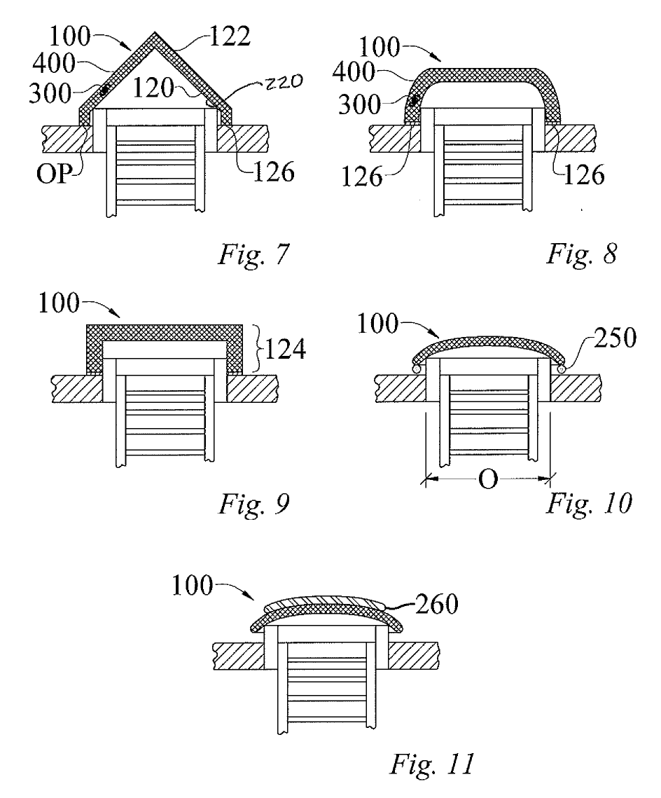

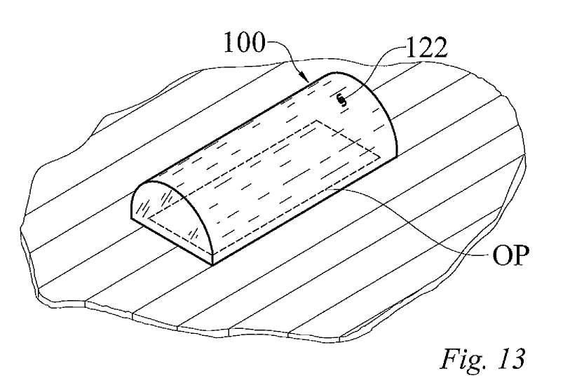

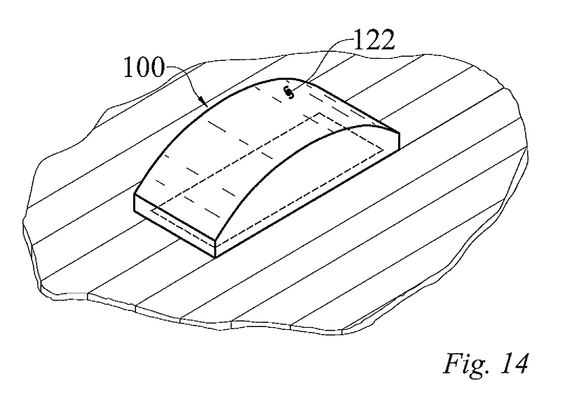

In one embodiment, the instant invention is a flexible fire-resistant thermally insulated composite structure (100) designed to pass through an opening (O) having an opening periphery (OP), seen well in FIGS. 5 and 13, among others. Various embodiments of the structure (100) are illustrated in an installation designed to insulate prior art attic stair devices like those shown in FIGS. 1-3, or may be other openings without stairs. The insulation device generally includes a flexible composite structure (100) having an inner surface (120), an outer surface (122), a composite structure mass (124), seen well in FIGS. 1 and 9. For purposes of this specification, the composite structure mass (124) simply represents the total mass, bulk, or weight of the structure (100). There is at least one thermally insulative layer (300), and at least one protective layer (400) in contact with at least a portion of the at least one thermally insulative layer (300), also seen well in FIGS. 7-11.

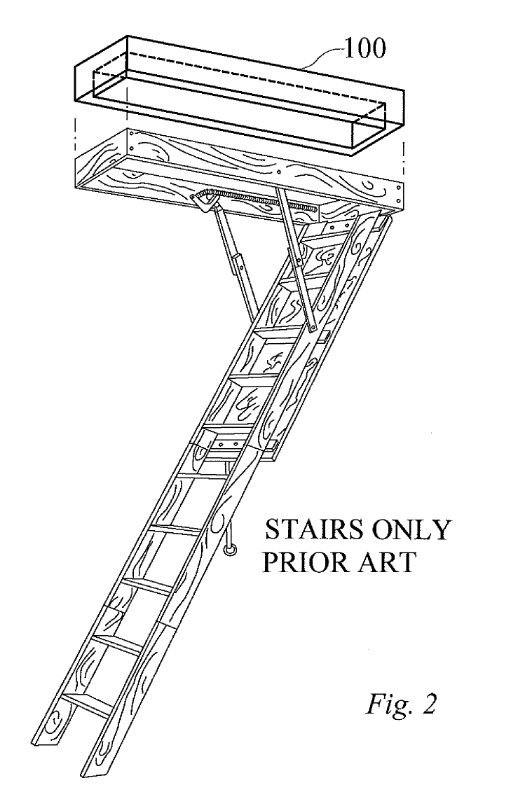

The flexible composite structure (100) is formed to have a self-supported installation configuration having an installation periphery (126). The self-supported installation configuration enables the flexible composite structure (100) to support the composite structure mass (124), seen in FIGS. 7-9. In some embodiments, such as those seen in FIGS. 1-3, the structure is self-supporting due to the stiffness of the insulative layer (300), the protective layer (400), or sometimes both. The structure (100) may be of virtually any shape, so long as the opening periphery (OP) is covered, and illustrative structure (100) shapes may be seen in FIGS. 6 and 13-15. One such shape is substantially triangular when looking from an end view with enclosed ends, similar to a “pup tent”, as illustrated in FIG. 1, 5, 6, 7, 16, 18, or 21. Other embodiments are rectangular as illustrated in FIG. 2, 3 or 9; curvilinear, flat, polygonal, nearly any other shape or combination thereof; some of which are illustrated in the FIGS.

Additionally, the flexible composite structure (100) may have a collapsed transit configuration. The collapsed transit configuration may have a transit periphery wherein a portion of the flexible composite structure (100) is compressed such that the transit periphery is less than the installation periphery (126) and the installation periphery (126) is greater than the opening periphery (OP), seen in FIG. 5. This allows the flexible structure (100) to be easily compressed in one or more directions, to allow the compressed structure (100) to easily pass through an opening (O) for installation, as can be envisioned from the structures seen in FIG. 5.

In another embodiment, the flexible composite structure (100) may be rated to at least a Class C fire rating. This may be or particular significance in installations where an ingress or egress means, such as an attic stair, may represent a significant break in an otherwise fire resistant insulation installation. As will be discussed at greater length below, such a fire rating may be achieved due to the fire resistance inherent to any one of the layers (300, 400), or to the combination of the fire resistance of the combination of the layers (300, 400); and may be supplied or augmented by the application of suitable fire retardants or additional structural elements to any part of the structure (100).

In one embodiment, the insulative layer (300) may include at least one layer of comprising a blend of meltblown fiberglass and polyester fibers. A typical product of this type is marketing under the trade name VERSAMAT™ by Owens Corning, Inc.; Granville, Ohio. In still another embodiment, the insulative layer (300) may include at least one layer of flexible duct media. A typical product of this type is marketed under the name Flexible Duct Media FIBERGLAS™ Insulation, Owens Corning, Inc.; Granville, Ohio. Both of these materials, and many others known in the art, tend to possess a stiffness such that when used as the insulative layer (300), enables the resulting structure (100) to support a significant portion of its own weight. In certain embodiments, the stiffness of the insulative layer (300) is sufficient to support the entire weight of the structure (100), as seen in FIGS. 1-3.

In another embodiment, the insulative layer (300) may comprise a nylon blend. In yet another embodiment, the insulative layer (300) may comprise a lofted insulative material. By way of example and not limitation, the lofted insulative material may comprise a lofted fiberglass, of many different varieties, all well-known in the art. In another embodiment, the insulative layer (300) may include at least one layer of flexible elastomeric foam. The flexible elastomeric foam may have a stiffness capable of supporting at least fifty percent of the weight of the composite structure mass (124). In an embodiment, the insulative layer comprises a more rigid foam, such as Foamular®, available from Owens Corning

In yet another embodiment, the insulative layer (300) may be treated with a fire retardant. Such a fire retardant may complement any inherent fire resistance of the insulative layer (300), the protective layer (400), or both; or it may provide sufficient fire resistance when the materials of the insulative layer (300), the protective layer (400), or both, are lacking.

In some embodiments, the protective layer (400) encapsulates the thermally insulative layer (300), as seen in FIGS. 8-11. In such embodiments, the protective layer (400) completely covers the insulative layer (300), protecting the insulative layer (300) from soil or damage. In other embodiments, the protective layer (400) may only partially cover the insulative layer (300), as seen in FIG. 7, where an exposed edge of the insulative layer (300) may be seen in contact with the opening periphery (OP) at the installation periphery (126). For example, the protective layer (400) may only cover the outside surface (124) of the structure (100). Such embodiments may have the additional advantage of allowing an edge of the insulative layer (300) to be exposed at the installation periphery (126), again as seen in FIG. 7, thus possibly improving the thermal seal between the structure (100) and the surface on which it rests.

In another embodiment, the protective layer (400) may include at least one foil layer. Such an embodiment may have the additional advantage of reducing radiant heat transfer, and such a layer may be applied to the inner surface (120), the outer surface (122) or both; depending on the characteristics desired. In yet another embodiment, the protective layer (400) may comprise a nylon blend or may include at least one polyvinylchloride layer and may also comprise polyester and/or polyester blends. In yet another embodiment, the protective layer is integrally formed on a surface of the insulative layer, such as by heating a Versamat® or polymer fiber insulative layer to form a skin on the surface of the insulative layer. In yet another embodiment, the protective layer may not be required.

In still another embodiment, the protective layer (400) may be treated with a fire retardant. Such a retardant may increase the fire retardant nature of the protective layer (400), and may improve the fire resistance of the overall structure (100) by adding to any fire resistance provided by the insulative layer (300).

In one embodiment of the flexible fire-resistant thermally insulated composite structure (100), at least a portion of the insulative layer (300) and at least a portion of the protective layer (400) are bonded together. Such bonding may increase the durability of structure (100) and make manipulation of the structure (100) easier. The bonding of the insulative layer (300) and the protective layer (400) may be accomplished by a bonding means. By way of example and not limitation, the bonding means may be selected from one of the group comprising heat lamination, adhesives, and glues.

In another embodiment, the flexible fire-resistant thermally insulated composite structure (100) may bear surface indicia (220) for orienting the structure (100) in relationship to the opening (O). Typically, such indicia (220) would enable a user to properly orient the structure (100) relative to the opening (O) so that the best possible thermal seal was achieved along the installation periphery (126). By way of example only, printed indicia (220) on the inside surface (120) of the structure (100) may help indicate when the structure (100) is centered above the opening (O).

In yet another embodiment, the flexible fire-resistant thermally insulated composite structure (100) may further include at least one grip enhancing device (270), as seen in FIGS. 6 and 17. Such grip enhancing devices (270), which may typically be handles or tabs, allow the easy manipulation of the structure (100) while minimizing the chances of damage to the structure (100).

In still another embodiment, the flexible fire-resistant thermally insulated composite structure (100) may have a rotable attachment (230). The rotable attachment (230) may be attached to at least one section of the installation periphery (126) surrounding the opening (O). Such an installation, as seen in FIG. 17, allows the structure to rotate away from the opening (O) for ingress and egress while the structure (100) would tend to remain properly oriented relative to the opening (O). By way of example and not limitation, the rotable attachment (230) may be at least one section of hook and loop attachment, flaps, magnets, hinges, or the like.

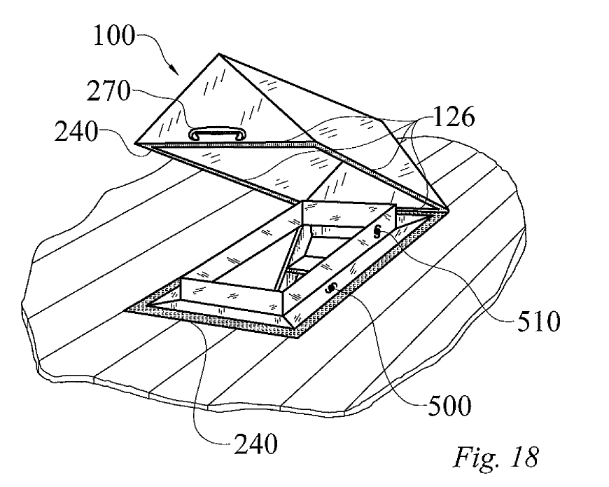

In one embodiment of the flexible fire-resistant thermally insulated composite structure (100), the installation periphery (126) may have a releasable attachment (240), seen in FIGS. 17-18. The releasable attachment (240) is designed for releasably attaching the installation periphery (126) to the opening periphery (OP). The releasable attachment (240) may be selected from the group of attachments consisting of flaps, magnets, hook and loop closures, snap closures, and zippers. Such a releasable attachment (240) tends to improve the thermal seal at the region of the junction of the installation periphery (126) and the opening periphery (OP). A releasable attachment (240), such as that seen in FIGS. 17-18, also tends to keep the structure (100) properly aligned with the opening (O), but, being releasable, also allows for ingress and egress when needed. the above examples of releasable attachments (240) are intended by way of illustration only; as the term “releasable attachment” is used in this specification, it is intended to include all releasable attachments as would be know to those skilled in the art.

In yet another embodiment, seen in FIG. 10, the flexible fire-resistant thermally insulated composite structure (100) may further include a plurality of weight elements (250). This is particularly valuable when the inherent stiffness of the structure (100) is relatively low, as the weight elements (250) may tend to keep the structure stretched across the opening (O) without an excess sag. Weight elements (250) may also partially compensate for the relatively low weight of some embodiments of the structure (100), and tend to keep the structure (100) properly aligned with the opening (O) and less susceptible to unintended movement due to accidental contact or jostling.

In still another embodiment, seen in FIG. 12, the flexible fire-resistant thermally insulated composite structure (100) may further include at least one batten (260). The at least one batten (260), which may generally be formed with or attached to any surface or part of the structure (100), may be attached in some embodiments to the group of layers consisting of the insulative layer (300) and the protective layer (400). The provision of battens (260) may have a plurality of beneficial effects, which would be known to those skilled in the art, and only some of which are discussed herein.

Battens (260) may stiffen a structure whose inherent stiffness is inadequate to support the structure without excessive sag. Battens may also help a structure (100) maintain its shape in any dimension. Furthermore, battens (260) may improve the overall durability and handling ease of the structure (100).

Additionally, the at least one batten (260) may be a slap batten. A slap batten is defined, for the purpose of this disclosure, as a batten (260) comprising a plurality of resilient layers such that the layered, resilient batten (260) may be straightened out, creating tension within the resilient layers, and therefore within the batten (260). The straightened batten (260) may then be slapped into position, for example after the structure is placed in approximate installed position, causing the resilient batten to spring back into a curve which then forms the final installed position.

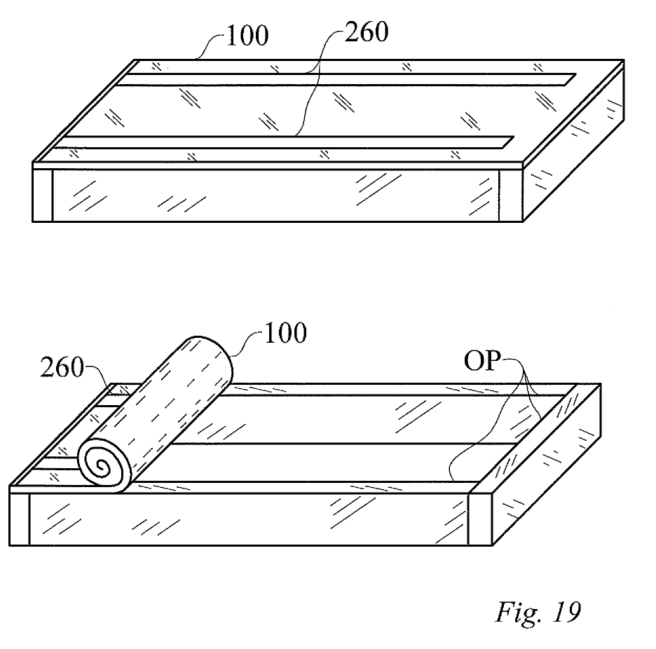

In yet another embodiment, seen in FIG. 19, battens (260) may be formed to create a curl in an otherwise generally flat structure (100). A mechanism may be provided by which the insulative layer (300) and the protective layer (400) might be rolled up against the resistance of such battens (260). The battens (260) could equally be at rest in a curled position, in which case they would be tensioned by unrolling into a straightened position; or be at rest in a straightened position, in which case they would tensioned by rolling into a curled position.

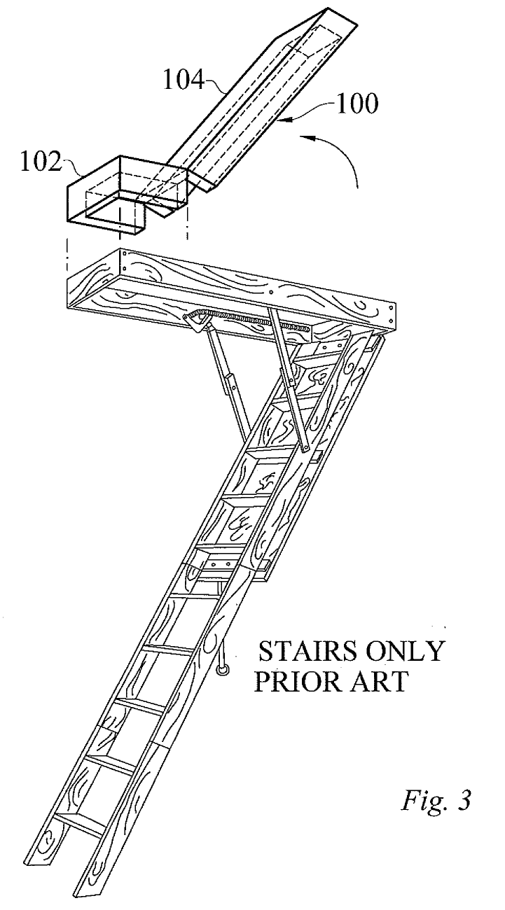

In one embodiment, the flexible fire-resistant thermally insulated composite structure (100) may further comprise a plurality of sections (102, 104), as seen in FIG. 3. Each of the plurality of sections (102, 104) generally includes a flexible composite structure (100) having an inner surface (120), an outer surface (122), a composite structure mass (124), at least one thermally insulative layer (300), and at least one protective layer (400) in contact with at least a portion of the at least one thermally insulative layer (300). Such a sectional construction may, particularly if the structure (100) is large, enable easier installation and removal of the structure (100) or may simplify ingress and egress through an opening (O)

In another embodiment, each of the plurality of sections (102, 104) is configured to at least partially overlap. Additionally, each of the plurality of sections (102, 104) may be releasably attached to another of the plurality of sections (102, 104). Such attachment, again as seen in FIG. 3, may help keep the structure (100) together, and may help improve the thermal seal between the sections (102, 104).

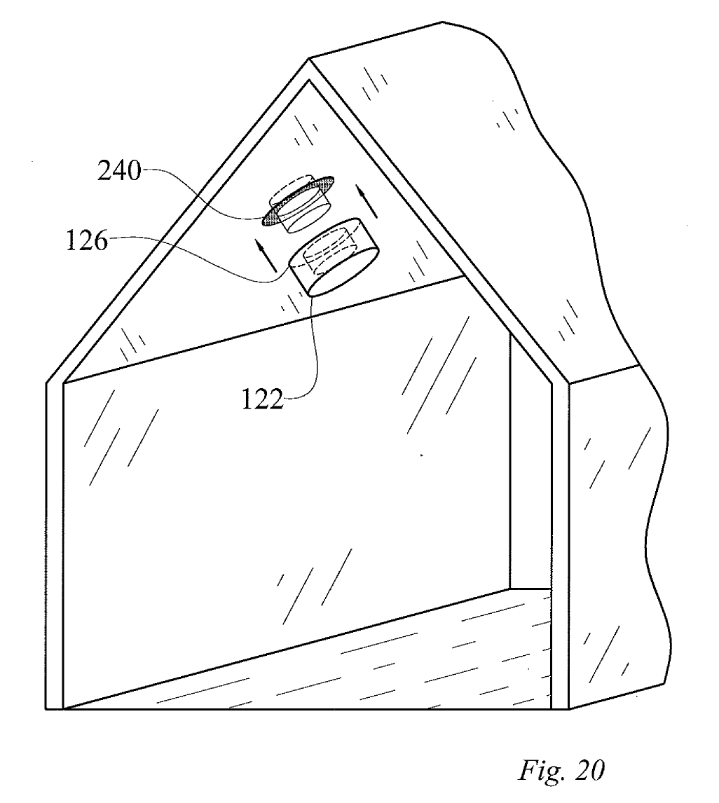

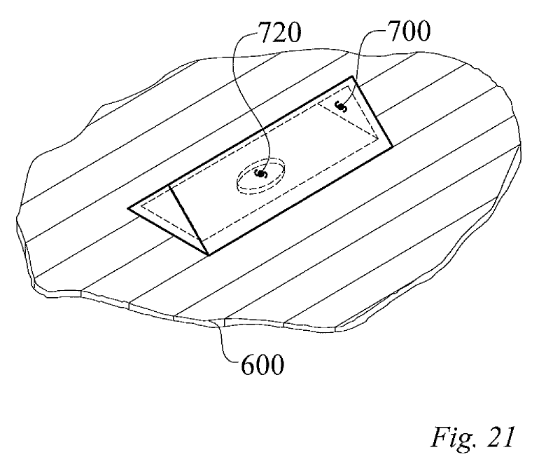

In other embodiments, such as those seen in FIGS. 20 and 21, not necessarily designed to be passed through an opening, the flexible fire-resistant thermally insulated composite structure (100) generally includes a flexible composite structure (100) having an inner surface (120), an outer surface (122), a composite structure mass (124), at least one thermally insulative layer (300), and at least one protective layer (400) in contact with at least a portion of the at least one thermally insulative layer (300). The flexible composite structure (100) may be formed to have a self-supported installation configuration having an installation periphery (126). Additionally, the flexible composite structure (100) may be designed to support the composite structure mass (124).

The flexible fire-resistant thermally insulated composite structure (100) may also include a bottom (600), as seen in FIG. 21. The bottom (600) may be attached circumferentially to the installation periphery (126) to form an interior volume (700) within the structure (100). One skilled in the art would appreciate that such an insulative structure (100) could be used as a shelter, possibly deployed under emergency conditions. In such an embodiment, the flexible fire-resistant thermally insulated composite structure (100) may have an ingress and egress means (720), which in various embodiments may comprise a hole, slit, door, flaps or the like, that connects the interior volume (700) with the outside environment. Emergency personnel, such as fire fighters, could carry the structure in a compressed configuration, and then easily expand the structure to take shelter in an emergency. Depending on the fire resistance, discussed above, such as structure (100) could provide shelter in conditions ranging from ambient environments conditions to the extreme heat of certain fires.

The insulative structures of the instant invention are not limited to embodiments designed to rest on generally horizontal surfaces. For example, it may be desirable to utilize such a structure (100) to block an attic fan, or other roof penetration, during certain seasons of the year. Such an embodiment is illustrated in FIG. 20.

In one such typical embodiment, again seen in FIG. 20, the flexible fire-resistant thermally insulated composite structure (100) generally includes a flexible composite structure (100) having an inner surface (120), an outer surface (122), a composite structure mass (124), at least one thermally insulative layer (300), and at least one protective layer (400) in contact with at least a portion of the at least one thermally insulative layer (300). The flexible composite structure (100) may be formed to have a self-supported installation configuration having an installation periphery (126). Additionally, the flexible composite structure (100) may be designed to support the composite structure mass (124). The flexible fire-resistant thermally insulated composite structure (100) may also include a releasable attachment (240). The releasable attachment (240) is configured for releasably attaching the installation periphery (126) to a surface inclined from the horizontal. Such an attachment, by way of example only, may be configured as a continuous or partially circumferential hook and loop closure section, could hold the structure (100) in releasable contact when the installation does not rest on a horizontal surface.

In another embodiment, the flexible fire-resistant thermally insulated composite structure (100) may be a component of a system for insulating an opening. Such a system, as is seen well in FIG. 18, allows at least in part for the retention of loose insulation or other debris in a typical attic installation. The system may generally include a flexible composite structure (100) having an inner surface (120), an outer surface (122), a composite structure mass (124), at least one thermally insulative layer (300), and at least one protective layer (400) in contact with at least a portion of the at least one thermally insulative layer (300).

The flexible composite structure (100) may be formed to have a self-supported installation configuration having an installation periphery (126). The self-supported installation configuration enables the flexible composite structure (100) to support the composite structure mass (124). Additionally, the flexible composite structure (100) may have a collapsed transit configuration. The collapsed transit configuration may have a transit periphery wherein a portion of the flexible composite structure (100) is compressed such that the transit periphery is less than the installation periphery (126) and the installation periphery (126) is greater than the opening periphery (OP).

The system may also include a collar (500), seen well in FIG. 18, disposed about and attached to the opening periphery (OP). The collar (500) may include at least one sidewall (510) raised above the plane of the opening (O). The collar (500) and associated sidewall (510) will decrease the natural tendency of any loose insulation, or other debris, from falling through the opening (O). The collar and sidewall may be clear, translucent, or opaque; and may comprise materials having a wide range of stiffness.

By the application of techniques well-known in the art, the structure (100) could be made moisture-resistant, water-resistant, and resistant to insect, mold, or other undesirable infestation activity.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims.

We claim:

1. A flexible fire-resistant thermally insulated composite structure designed to pass through an opening having an opening periphery, comprising:
a flexible composite structure having an inner surface, an outer surface, a composite structure mass, at least one thermally insulative layer, and at least one protective layer in contact with at least a portion of the at least one thermally insulative layer;
wherein the flexible composite structure is formed to have a self-supported installation configuration having an installation periphery wherein the flexible composite structure supports the composite structure mass, and having a collapsed transit configuration having a transit periphery wherein a portion of the flexible composite structure is compressed such that the transit periphery is less than the installation periphery and the installation periphery is greater than the opening periphery.

2. The structure according to claim 1, wherein the protective layer encapsulates the thermally insulative layer.

3. The structure according to claim 1, wherein the structure has a shape, when viewed from an end thereof, the shape selected from a group consisting of one of a triangular, rectangular, curvilinear, and polygonal shape.

4. The structure according to claim 1, wherein the structure is rated to at least a Class C fire rating.

5. The structure according to claim 1, wherein the insulative layer further comprises one of the group consisting of fiberglass, polyester fibers, nylon fibers, a lofted insulative material, flexible duct material, elastomeric foam, and combinations thereof.

6. The structure according to claim 1, wherein the protective layer further comprises a material selected from the group consisting of: foil, nylon, polyvinylchloride, polyester, fiberglass, and combinations or mixtures thereof.

7. The structure according to claim 5, wherein the insulative layer comprises lofted fiberglass.

8. The structure according to claim 5, wherein the insulative layer comprises of flexible elastomeric foam having a stiffness supporting at least fifty percent of the weight of the composite structure mass.

9. The structure according to claim 1, wherein one or more of the insulative layer and protective layer, or both, are treated with a fire retardant.

10. The structure according to claim 1, wherein at least a portion of the insulative layer and a portion of the protective layer are bonded together by a bonding means selected from the group consisting of heat lamination, adhesives, glues, and combinations thereof.

11. The structure according to claim 1, wherein the structure further bears surface indicia for orienting the structure in relationship to an opening.

12. The structure according to claim 1, wherein the structure has a rotable attachment attaching at least one section of the installation periphery surrounding an opening.

13. The structure according to claim 12, wherein the rotable attachment is at least one section of hook and loop attachment.

14. The structure according to claim 1, wherein the installation periphery has a releasable attachment releasably attaching the installation periphery to the opening periphery.

15. The structure according to claim 14, wherein the releasable attachment is selected from the group of attachments consisting of flaps, magnets, hook and loop closures, snap closures, zippers and combinations thereof.

16. The structure according to claim 1, wherein the structure further comprises a plurality of weight elements.

17. The structure according to claim 1, wherein structure further comprises at least one batten attached to one of the insulative layer or the protective layer.

18. The structure according to claim 17, wherein the at least one batten is a slap batten.

19. The structure according to claim 1, wherein the structure further comprises at least one grip enhancing device.

20. The structure according to claim 1, wherein the structure is formed as a plurality of sections, each piece having;
a flexible composite structure having an inner surface, an outer surface, a composite structure mass, at least one thermally insulative layer, and at least one protective layer in contact with at least a portion of the at least one thermally insulative layer;
wherein the flexible composite structure is formed to have a self-supported installation configuration having an installation periphery wherein the flexible composite structure supports the composite structure mass, and having a collapsed transit configuration having a transit periphery wherein a portion of the flexible composite structure is compressed such that the transit periphery is less than the installation periphery and the installation periphery is greater than the opening periphery.

21. The structure according to claim 20, wherein each of the plurality of sections at least partially overlap.

22. The structure according to claim 21, wherein each of the plurality of sections is releasably attached to another of the plurality of sections.

23. A structure for insulating an opening having an opening periphery with a collar disposed about and attached to the opening periphery comprising;
a flexible composite structure having an inner surface, an outer surface, a composite structure mass, at least one thermally insulative layer, and at least one protective layer in contact with at least a portion of the at least one thermally insulative layer;
wherein the flexible composite structure is formed to have a self-supported installation configuration having an installation periphery wherein the flexible composite structure supports the composite structure mass, and having a collapsed transit configuration having a transit periphery wherein a portion of the flexible composite structure is compressed such that the transit periphery is less than the installation periphery and the installation periphery is greater than the opening periphery; and
having at least one sidewall raised above the plane of the opening.

24. A flexible fire-resistant thermally insulated composite structure, comprising:
a flexible composite structure having an inner surface, an outer surface, a composite structure mass, at least one thermally insulative layer, and at least one protective layer in contact with at least a portion of the at least one thermally insulative layer;
wherein the flexible composite structure is formed to have a self-supported installation configuration having an installation periphery wherein the flexible composite structure supports the composite structure mass, and
a bottom, attached circumferentially to the installation periphery, forming an interior volume within the structure.

25. The structure according to claim 24, wherein the structure has an ingress and egress means connecting the interior volume of the structure with the outside environment.

26. A flexible fire-resistant thermally insulated composite structure, comprising:
a flexible composite structure having an inner surface, an outer surface, a composite structure mass, at least one thermally insulative layer, and at least one protective layer in contact with at least a portion of the at least one thermally insulative layer;
wherein the flexible composite structure is formed to have a self-supported installation configuration having an installation periphery wherein the flexible composite structure supports the composite structure mass, and
a releasable attachment releasably attaching the installation periphery to a surface inclined from the horizontal.
